(19) United States
(12) Patent Application Publication
(10) Pub. No.: US 2026/0340013 A1
(43) Pub. Date: Oct. 29, 2026

(54) DIGITAL CONTENT ENHANCEMENT USING A LOCATOR SYSTEM, AN ENABLER SYSTEM, OR THE COMBINATION

(71) Applicant: EnablesU Inc., Vancouver, WA (US)

(72) Inventors: James E. Owen, Vancouver, WA (US); Melinda Lilly Thompson, Vancouver, WA (US); Andrew William Shewbart, Spicewood, TX (US); Scott Melton Thompson, Vancouver, WA (US)

(21) Appl. No.: 19/323,042

(22) Filed: Sep. 9, 2025

Related U.S. Application Data
(60) Provisional application No. 63/793,530, filed on Apr. 23, 2025.

(51) Int. Cl. G06F 16/338; G06F 3/0481; G06F 16/332; G10L 13/02; G10L 15/26

(52) U.S. Cl. CPC G06F 16/338; G06F 3/0481; G06F 16/332; G10L 13/02; G10L 15/26

(57) ABSTRACT

A system includes a user interface that presents a query window to a user, a walled garden comprising a set of selected digital resources, a converter to convert any closed-format digital resources in the walled garden to an open tagged format and to segment digital resources into chunks, an artificial intelligence (AI) contextual search module to retrieve chunk sets comprised of cohesive sets of content from the walled garden, a locator having a locator user interface that allows the user to enter the query and uses the AI contextual search module to locate chunk sets relevant to the query in the walled garden and displays the chunk sets on the user interface without modification of the content, and an enabler to provide one or more accommodations to assist the user with consuming the content. The system may include only one of the locator and the enabler.

### CROSS-REFERENCE TO RELATED APPLICATIONS

This disclosure is a non-provisional of and claims benefit from U.S. Provisional Application No. 63/793,530, titled “DIGITAL CONTENT ENHANCEMENT USING A LOCATOR SYSTEM, AN ENABLER SYSTEM, OR THE COMBINATION,” filed on Apr. 23, 2025, the disclosure of which is incorporated herein by reference in its entirety.

### TECHNICAL FIELD

This disclosure relates to enhancements for accessing and consuming digital content, more particularly to providing control of sources and enablements for consuming digital content.

### BACKGROUND

Traditional generative artificial (AI)-powered query tools for digital content typically generate direct answers or summaries. The term “generative AI” as used herein means AI models, such as large language models (LLMs), that include a transformer that can receive inputs and produce answers based upon the input. Asking a question of AI and getting an answer is appropriate in some situations. It is counterproductive for those trying to learn because AI thinks for the user. The learner becomes a passive consumer of information. Furthermore, these query tools may provide damaging inaccuracies due to AI hallucinations because they provide textual or visual answers outside a body of work that has undergone vetting or constraint. The query tools also offer the opportunity for a student to cheat by copying and pasting AI's answer or paraphrasing it.

Currently, writing an AI prompt about assigned reading causes issues with many learnings. The AI tells the learner what to think about that reading or gives an answer. Students struggle to form and communicate an independent answer once they have been exposed to AI's answer. The ability of learners to generate their own thoughts and ideas requires protection. Outside of the student learning environment, other users that want to search and learn on their own face the same challenges with typical AI-powered interfaces.

A need exists for students and other learners to locate answers to their queries from authoritative content. However, traditional skim-reading techniques implemented across a considerable amount of content may increase cognitive load, leading to more opportunities for distraction, be too challenging for non-experts attempting to wade through dense texts to find answers to their queries, and be too time consuming. Further, no AI-powered query tools exist to support users who need assistance locating answers to their queries. These include, as examples, reluctant readers, English or other language learners, those with special needs, those who must review materials in an expeditious manner, and those who need to find specific information that cannot be located by a keyword search. These users need help in locating pertinent content so they can ascertain the answers to their queries.

The discussion below uses an educational context to describe the elements of the embodiments. However, this example environment provides examples to demonstrate the embodiments and the capabilities of the system. No limitation is intended, nor should any be implied. Other applications of the embodiments are described below and are within the scope of the claims.

In addition, a need exists for a suite of AI-powered tools designed to support learners in their educational journeys, solutions that provide an alternative to traditional one-size-fits-all methods. Many students require additional support to understand their reading assignments, such as simplified English translations, read-to-me audio, definitions, and ADHD and dyslexia-friendly displays. Students who need more than one type of learning support often must use an assortment of tools.

Conventional methods that modify a textbook layout may disrupt images, diagrams, and overall formatting. They may also require additional storage of the modified file. They present an alternative version that differs substantially from the original material. These alternative presentations separate the student who uses them from the majority of the class.

The modifications make it obvious to classmates or others when a user needs additional assistance. This obvious difference can factionalize the students, segregating accommodated students and creating a social-emotional challenge in a group setting. The modifications may cause friction when the class is instructed to look at the same material (e.g., “Everyone look at paragraph 3 of page 20”). They detach the accommodated students from the original source material, potentially causing gaps in subject coverage. Further, they remove the accommodated student's agency to choose to read the original source material when it may be appropriate.

Whether writing or recording answers and responses, all challenged students should be supported in their attempts to communicate their ideas and knowledge rather than have their attempts stymied or replaced by answers written by AI. Some students may require speech-to-text accommodation that works with their assigned materials. Other learners may need a synergistic combination of different types of assistance that together create one result, such as a simplified version of the original material output via read-to-me audio or speech-to-text with translation.

Using multiple alternative versions with accommodations has other difficulties. For example, from a production point of view, the creation and maintenance of these alternatives costs more and increases the burden on content providers. From the instructor's and aide's points of view, the additional assistance needed for each alternative complicates their jobs.

Additionally, many textbooks and learning materials may have digital formats such as PDF, EPUB, MOBI and AZW. The proprietary nature of these formats and the complexity of others make it difficult to build products that extend their functionality. Designing a proprietary format that adds the necessary meta-data for location and enhancement functionality causes an extra problem, managing the copyright of the original source material. The augmented documents can reside on servers owned by the original textbooks' copyright holders or can be downloaded onto the end-user's devices only if they have heavy protections to avoid the undesired copying and distribution of the copyrighted material.

In addition, current AI-enhanced web search engines may hallucinate, create biased or incorrect summaries of online data and articles, not credit sources or provide URLs accurately, and decrease traffic to the sources of the information used to answer the query, negatively impacting businesses that rely on web traffic to provide content for free or generate revenue from ads that are priced according to the amount of traffic it receives. They may garner information from webpages that are part of the Robot Exclusion Protocol and others that should not be accessed by their web crawler. Traditional web searches may require sifting through sponsored and other results and partial information presented out of context. Once a user clicks on a result, they may then need to search the webpage for the pertinent information as there is often no indication of the location of the passage that addresses the query. A need exists for transparency, accuracy, efficiency, and appropriate treatment of information sources provided by web searches.

### BRIEF DESCRIPTION OF THE DRAWINGS

FIG. 1 shows an embodiment of digital content locator and provider system including enablements.

FIG. 2 shows an embodiment of a base display with a digital source.

FIG. 3 shows an embodiment of a base display with a digital source requiring user input.

FIG. 4 shows an embodiment of a query panel (query panel).

FIG. 5 shows an embodiment of a base display with an enhancements toggle.

FIG. 6 shows an embodiment of a base display with a digital source with the addition of an enhancements toggle and a highlighted chunk.

FIGS. 7 and 8 show embodiments of a user interface to allow a user to access locations of chunks after they have been found by the locator in response to a query.

FIG. 9 shows an embodiment of a enabled display applied over a base display.

FIG. 10 shows an embodiment of a base display with outlined chunks, indicating that a passage can be enhanced by enablements.

FIG. 11 shows an embodiment of an enablements display including the ability to invoke speech-to-text for user input.

FIG. 12 shows an embodiment of a user interface with a read-to-me capability.

FIG. 13 shows an embodiment of a user interface speech-to-text capability.

FIG. 14 shows an embodiment of a user interface with speech-to-text capability and a reviewing capability.

FIG. 15 shows a flowchart of an embodiment of a method to convert a textbook to a format of spans, chunks, and locations.

FIG. 16 shows a flowchart of an embodiment of operating a locator.

FIG. 17 shows a flowchart of an embodiment of providing enablements.

FIG. 18 shows a flowchart of an embodiment of generating enablements.

FIG. 19 shows a flowchart of an embodiment of a read-to-me enablement.

FIG. 20 shows a flowchart of an embodiment of a speech-to-text interaction.

### DETAILED DESCRIPTION

The following discussion will use several terms to encompass various topics. The term “base display” as used herein means a foundational layer that renders a digital book or other text-based content in its original, unmodified format, ensuring text, images, diagrams, and layout are common to all viewers. The base display can show scrollable pages, spreads, or other displays of the material. The term “base display set” means a base display version of all the digital-books in the walled garden in an educational environment. In a general use environment, such as a web or other content browser, the base display set may comprise selected digital content chosen from materials available on the web, or a defined set of digital content that may be user-defined, discussed in more detail below. In one some embodiments, such as those related to education contexts, the term “walled garden” means a chosen, vetted collection of digital content that could include a textbook, group of textbooks, activity books, exams, educational media, reference materials, books, videos, audio files, transcripts of video and audio files, and other content, but nothing outside the vetted collection.

As used herein, the term “vetted” applies to digital resources that are identified as part of the walled garden prior to a user accessing the resources. In the examples below, this may comprise a set of educational materials. Discussed in more detail below, this may also comprise a pre-defined collection of materials. In other contexts, such as in a web browser type of environment, the resources are not necessarily pre-defined or identified but selected based upon a user's or administrator's judgment. The term “selected” as used herein includes both vetted materials and selected materials, whether those materials are selected by the user or assigned, as in an educational context.

The term “digital source” means the original digital book or other digital content that can be shown in the base display and is part of the walled garden. The term “digital source set” means a grouping of digital books or media that can be shown in a base display set and consists of all the materials in the walled garden. The digital source set could include a book, textbook or group of textbooks, activity books, exams, educational media, reference materials, transcripts, legal briefs, scientific papers, and other assigned or selected digital content. The digital sources undergo conversion by a “converter” meaning a module converts the digital sources into HTML or other tagging format, such as PDF to HTML.

The base display may occasionally have “mini-panels” meaning floating panels that allow access to controls for relevant content locations. Similarly, the term “nav module” means a navigation and highlight module that shows a mini-panel over the base display and scrolls the base display to make specific chunks of text (such as paragraphs or other text) visible and highlighted in response to a query. A larger floating panel may present an “enablements display,” discussed below. As used herein, the term “enablement” means tools and interfaces provided to the user that enable them to consume the content. “Enablements processor” means the component that dynamically provides the enabler display.

The term “chunk” means an individual cohesive section of content from the digital source set. “Chunk sets” are sets of these cohesive sections of content. Chunks are located by the user reading the content or by using the “locator,” meaning a module that responds to user queries by retrieving and highlighting locatable chunks. A “locatable chunk” means a chunk that the locator can scroll to in the base display set. The locatable chunk is visible and can be highlighted. Locatable chunks comprise content used as a response to a user's query in which the answer can be accessed or inferred in the educational context. In the general user context, the locatable chunks comprise content found in the user-defined walled garden, discussed in more detail below, that provides information to the user in response to the user's query.

The locator is configurable through a “locator config” meaning configurations that apply different settings to different types of users, such as students, teachers, editors, by age group, etc., in the educational context. In the general user context, the configurations may apply different settings, access to content, etc., based upon subscription level or user characteristics, such as age, location, language, etc. “Query panel” means a panel where users enter their queries. A language processing module converts the query into searchable items, with the AI interface providing language processing, using natural language processing, generative AI transforms, speech recognition, and other tools. The query is handled by a “search module,” meaning an AI-driven contextual search module that retrieves locatable chunk locations in response to queries entered in the query panel.

As discussed above, among the capabilities of the system is its ability to provide enablements and enhancements. As used here, “enhancements” is an overarching term that includes both the locator's functionality and the enabler's accommodations. One type of enhancement comprises enablements that consist of a selected accommodation, pair, or group of accommodations for individual chunks. The term “accommodation” means a modification to assist users or a process to augment base display-set to improve a selected user's ability to understand the materials or to express themselves. The system provides various types of accommodations. “Read-accommodation” means an accommodation to enhance a digital source set (to improve a selected user's understanding), such as simplified-language, translations, read-to-me, and in the future, ADHD, and dyslexia typography. “Speech-to-text” means an enablement that supports dictation. This may include speech-to-text-1, which means speech-to-text for users who cannot read, and speech-to-text-2, which means speech-to-text for users who can read but cannot communicate effectively by typing. “Status text,” informs users of their current stage in the recording process. The status text is used primarily for speech-to-text-1 but may be used optionally with speech-to-text-2. “Write-accommodation” as used here means an accommodation that assists users interacting with editable fields and text areas in expressing themselves. Write-accommodations may include speech-to-text as a means of accomplishing written assignments. “Read-to-me” means an enablement that reads aloud a chunk (audio output). “Simplified language” means an enablement that accompanies the chunk, providing language of the same meaning that is easier to read and understand and that aligns with the student's abilities. “Translation” means an enablement that translates the chunk to a given language, such as Spanish or Chinese.

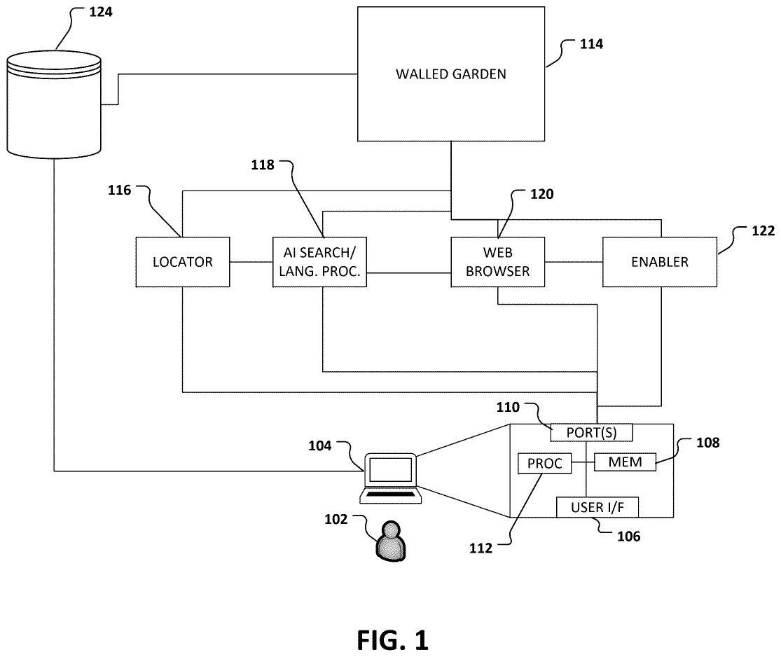

The embodiments disclosed herein involve an integrated system for enhancements to digital books and related materials. While much of the discussion below addresses the embodiments in an education environment, one skilled in the art will recognize that the components of the system apply more broadly than that environment. FIG. 1 shows an overall view of an embodiment of the system. The user 102 will generally employ a computing device 104 of some type. The computing device comprises any device that includes one or more processors 112 that are configured to execute computer instructions in the form of code to implement the embodiments. The memory 108 may contain those instructions, or the instructions may reside in a memory on-board with the one or more processors 112. The memory 108 also represents any memory that may store, temporarily or permanently, all or portions of the converted materials, discussed below, in the walled garden. This includes local memory 108 at the computing device 104 or in a cloud or remote store such as 124 from FIG. 1. The device has one or more communications ports 110, wired or wireless or both, that allow the computing device to communicate with other computing devices and memories. The user interface (I/F) comprises user input devices, such as a mouse, keyboard, touch screen, and microphones, and devices used to communicate with the user including displays, speakers, etc.

The different modules in the system, including the locator, the enabler, the mini-display, overlays, enablement displays, user interfaces and the like, comprise software, meaning computer-executable code operating on one or more processors to cause the one or more processors to operate the various modules and capabilities discussed below.

User 102 interacts with the system through the computing device 104, which allows the user access to different modules running on the computing device, either from local memory, or from a remote server as software as a service (SaaS). The system includes several modules, discussed in detail below. The integrated system combines two main features of a locator 116 for query-based search and navigation of materials, and an enabler for adaptive accommodation overlays 122 of any materials being viewed. The digital content, or digital materials, may come from the walled garden, or may come from other sources. The locator assists users in looking for answers to their queries about digital content, and in one embodiment employs an artificial intelligence (AI) contextual search module 118. The enabler assists users in comprehending the content. The combination of the two assists users in locating and understanding the answers to their queries but may also operate as stand-alone modules. The system can be used with one or more pieces of digital content that have undergone a conversion process that provides tagged versions with added metadata necessary to support either or both of the above features. In one embodiment the content is in Portable Document Format (PDF) and the tagged results are in HyperText Markup Language (HTML). The conversion process delivers the converted digital book and preserves its presentation, including its text, images, and design.

The locator 116 retrieves and highlights relevant content, such as book sections, based on user queries. The enabler 122 applies non-intrusive, adaptive accessibility features onto the same display. As discussed below, the system may allow more general users besides learning users to employ this system for general web browsing and other ways to consume digital content.

The system uses a base digital content display. In the examples below, the views are of digital books, but the views may be of other forms of digital content, such as videos and audio files. The base display can present any item in the digital source set: a digital book or set of digital books or media that can be described in text. These items include a vetted textbook or group of textbooks, activity books, exams, general books, educational media, reference materials, transcripts, legal briefs, scientific papers, and other assigned or selected digital content. These materials can be viewed in their entirety by scrolling or by similar methods, such as by turning a digital page. The individual cohesive sections of content, referred to here as chunks, shown by the base display can include a paragraph, a title or subtitle, a caption, a text description of other media, and other discrete content. Using separate windows, the base display could present more than one digital source at the same time. The base display set has an assortment of digital content from the walled garden that can be presented in the base display.

The locator implements an AI-driven Contextual Search Module to retrieve chunk set locations in response to natural language queries. The locator's Navigation and Highlight Module, the nav module, shows a mini-panel that floats over the base display. One by one, the locator finds and highlights chunks that contain pertinent information for the user to be able to answer the query they have posed. By giving users the tools to answer their own queries, the locator assists rather than thinking for the user, an issue found in much of current AI. The original, digital source of content in the base display is presented without modification other than the highlight. Because the base display can show each digital source in its entirety, the user can read the chunks in context, if desired. The same is true of the base display set as it relates to the presentation of the digital source set.

The search module that handles the queries constrains the chunk locations within a walled garden. As discussed above in the definitions, the walled-garden consists of a digital source-set, such as a digital book or set of digital books or media, including a vetted textbook or group of textbooks, activity books, exams, educational media, general books, reference materials, and other assigned digital content. For applications outside of the educational context, the walled garden content may take on different meanings, as discussed below.

The application of AI in the search module will only present information from the walled garden, and that information is presented as highlighted locations, chunks, where the answer can be ascertained. No risk exists of AI hallucinations from the Internet or student cheating by copying and pasting from an answer provided by AI. The student must engage with the assigned content.

Consistent with other currently available and well-known search tools such as Google Chrome®, Bing®, etc., the locator assists a wide variety of time-conscious or challenged users in skimming materials and data. However, the locator's use of digital sources in a walled garden, combined with its method of efficiently presenting pertinent information in situ to answer queries is unique. It does not mimic prior art AI or prior art keyword searches. By going beyond indexes and keyword searches to provide users with what they need to answer their own questions, it enables them to efficiently focus on the information in the digital source set and learn. This addresses a common challenge with other AI supports. meaning any AI-related help, such as AI-based searches, chat systems, AI-brainstorming, as examples.

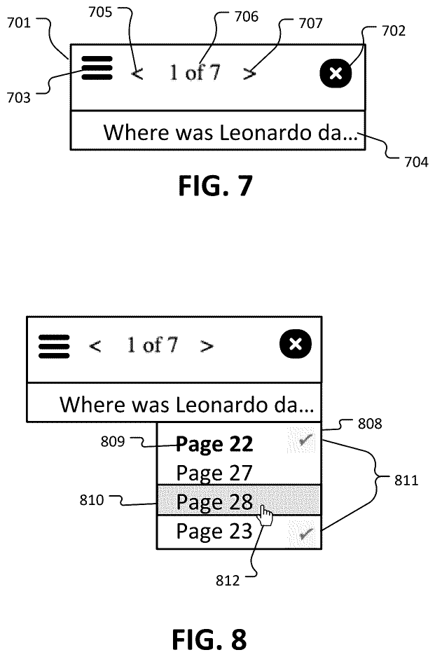

The locator can be readily adapted for web searches. With the locator's searches of the digital source set, the response to an Internet query would be to present the location with the best source of the information and highlight the pertinent text and/or other media on that webpage. Additional, pertinent location-based sources to the query could be accessed by clicking, as shown in FIGS. 7 and 8. The page numbers would be replaced by URLs. If needed, walled gardens could be created according to searchable topics or personalization for users, such as by age. The many web search engine issues currently available could be ameliorated by employment of the embodiments, a location-based search engine that leads users directly to the information they seek at its source.

The locator has a variety of configurations, locator configs that apply to different settings for students, teachers, and editors. These configurations can be customized, or a list could be provided, as discussed in more detail below.

The base display is augmented with an enhancements toggle. The enhancements toggle is an unobtrusive switch that lets the permitted user decide when to use the enhancements. The system provides an easy on/off that addresses the social-emotional challenges and gives users the power to decide when they want to be challenged by the standard digital source content and when they want to use the enabler and locator.

The enabler is activated by a user-controlled toggle, allowing seamless enabling/disabling of accessibility features. It applies an adaptive accessibility overlay, an enabler display, on the base display without altering the digital source's original presentation except by temporarily adding a highlight. This system includes an AI-driven enablement processor for dynamically generating, refining, and caching overlays and the enabler configurations that allow educators, admins, students, and other users to adjust settings as needed. The enabler tackles challenges such as students in the same class using very different materials for a topic that is intended to be taught cohesively and eliminates the need for users to manage a panoply of system-wide accessibility software.

When the enhancements toggle is activated, the locator responds to user queries in a query panel by retrieving and highlighting relevant sections from the digital source set as shown in the base display or base display set. This method ensures active engagement with the digital source while assisting the user by finding pertinent materials. It addresses challenges such as passive learning caused by being fed an answer and increased cognitive load. The locator avoids these issues because it finds and shows pertinent information for a user to figure out the answer(s) to their query from within the digital source set rather than replacing it.

Enablements provide accommodations to assist users in understanding the digital source set. The enabler presents enablements that accompany one chunk at a time. These enablements are shown in a specialized display (e-display).

The enabler display can consist of a movable dialog box located near the highlighted chunk to which it corresponds, a fixed panel, or some other type of display that presents an enabled chunk of the content that may include navigation controls (e.g., previous/next buttons), scrollable content, and dynamic text/audio synchronization. When the user clicks on a particular chunk, that chunk becomes highlighted, making it both easier to read and to find.

The embodiments offer enablements that support one chunk of content at a time to address the problems of challenged learners feeling overwhelmed by the amount of material in one-size-fits-all situations. The user can interact with the interface to adjust the enablements provided. An educator can determine which users are permitted to have access to the enabler and which enablements each student can receive.

The enabler can combine more than one enablement at a time. It can combine reading accommodations with one another, such as providing a user with two or more of simplified language, multi-language translations, and read-to-me. For translation enablements, the current implementation uses English as the base language, although English could be substituted with another base language as required. The enabler can also combine reading accommodations with writing accommodations, such as read-to-me with speech-to-text. The enabler can be quickly and easily dismissed by clicking a toggle.

The enabler has a variety of configurations that apply to different settings for students, teachers, publishers, editors, admins, general users, etc. that can be customized based on assigned user permissions.

A converter transforms a proprietary or closed format to an open tagged format with extended notations, metadata, and chunk delineation from a walled garden. It addresses some of the challenges of protecting intellectual property rights by circumventing the need to store a copy of the original source material to use it.

When integrated, the locator and enabler work in tandem on the same base display. Instead of AI providing an answer to a query, the locator supports users' educational journeys by showing where in the digital source to find the answer. When used in combination, the embodiments give users the tools to determine the answer for themselves and communicate it.

The locator retrieves and highlights relevant content based on a user's query, and the enabler subsequently applies personalized accessibility overlays to a chunk. This synergy enhances comprehension and user engagement while maintaining the integrity of the user's work and the original material's appearance and content.

The user queries are entered in the query panel. However, if users are unable to read and/or type in the base language, the query panel's elements could offer read-to-me and speech-to-text, and in certain cases, translation. The accommodations of the query panel will be determined by the individual's identified needs and not all possibilities are depicted in the figures. These query panel elements will support the enablements approved and in place for the users and will offer similar accommodations for them.

The functioning of the locator augmented by the enabler adds another feature. When the locator highlights a relevant chunk, it also must present an enabler display with any enablements approved for the user. As with the enabler alone, the user interacts with the accommodated chunk content, benefiting from both the original display and the additional accessibility features. However, the locator simultaneously shows the query panel and the mini-panel, allowing the user to interact seamlessly with both.

The combined locator and enabler have a variety of configurations, the locator configs enabler configs. The combination of the two may be presented seamlessly as a single set of configurations without distinguishing between the locator and enabler. For example, the locator could be presented as an enablement itself side by side with other enablements. Also, the enhancements toggle may apply to both, or there may be separate toggles, allowing the user to apply one or the other, both, or none.

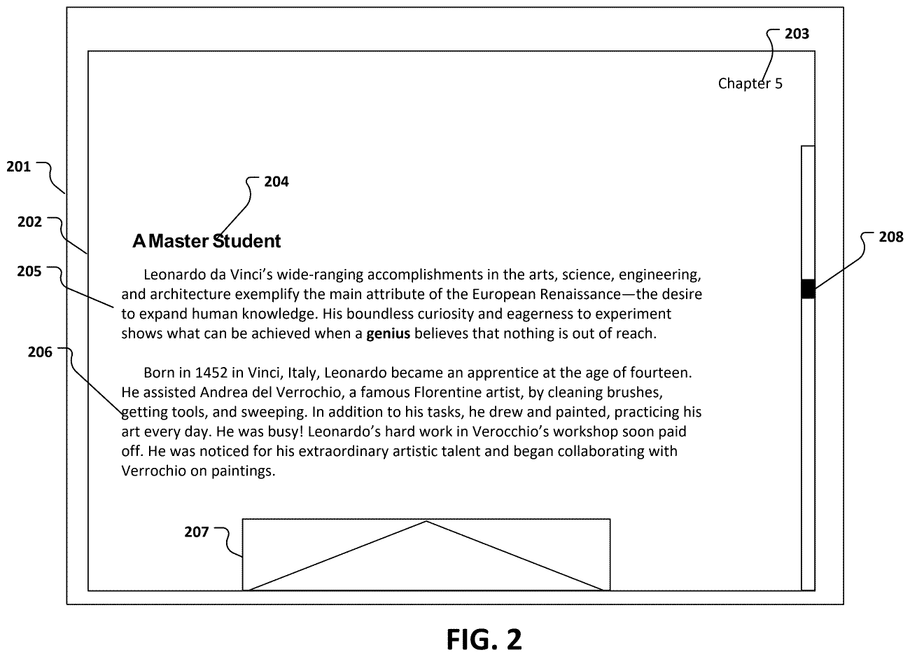

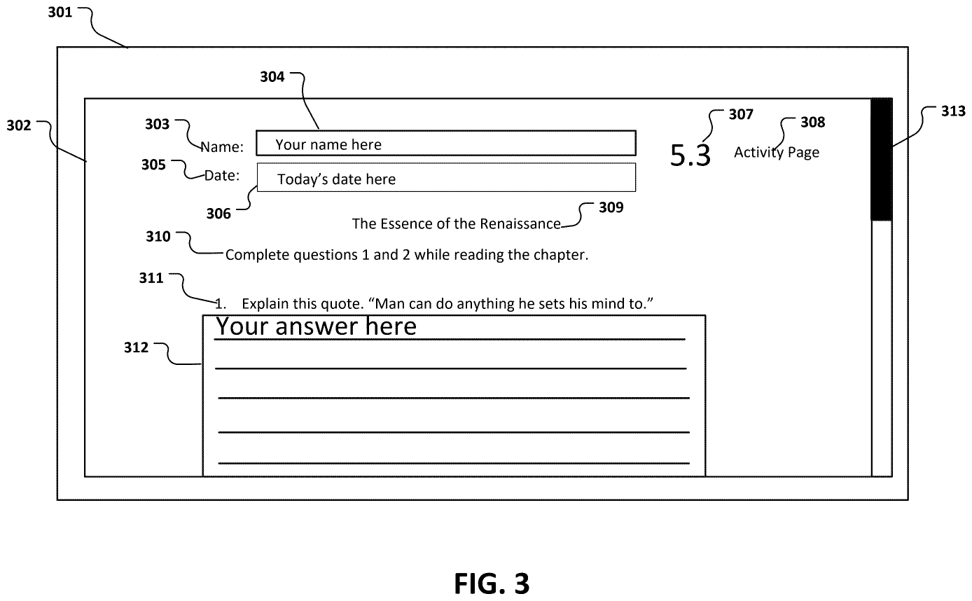

FIGS. 2 and 3 depict base displays from a base display set with digital source content. For example, the figures show a base display and digital source for a textbook and for an activity book. The outer frames, 201 and 301, typically are windows, and there may be multiple such frames overlapping or side-by-side to show a digital source-set. The embodiments add overlays to the base display set to address the needs discussed above.

FIG. 2 shows a base display with a digital source, in this example, a digital textbook. It renders the digital source with its original appearance, ensuring that text, images, diagrams, other media, and layout are common to all viewers. This display and FIG. 3 form the foundational layers upon which the locator and enabler operate. The display includes an outer frame 201, such as a window, with a scrolling display of textbook 202, which can be controlled by the scroll bar 208. The digital source navigation could also be implemented by other means such as left and right arrows to flip pages. The outer frame 201 may include other navigation or auxiliary controls not included in this diagram. The textbook contents typically include items such as a page number (not shown), a chapter number 203, a title 204, paragraphs 205 and 206, and illustrations 207.

Digital sources may include multiple titles and subtitles, illustrations, animations, buttons to play audio, or videos. The figures do not include these for simplification. In addition, the base display can be a base display set presenting more than one digital source but is shown in FIG. 2 as one digital source in one base display.

The individual cohesive sections of content, chunks, in 201 may include paragraphs such as 205 and 206, titles and subtitles 204, book sequence information 203, captions and text descriptions of illustrations 207, text descriptions of other media, and other discrete content.

Base displays may be shown one at a time, or as multiple overlapping or side by side windows. A base display can show any member of the digital source set, a digital book or set of digital books or media, including a vetted textbook or group of textbooks, activity books, exams, educational media, reference materials, and other assigned or selected digital content.

The digital source set consists of any materials within the walled garden. The digital source set may include text-based media and media that can be accompanied by a text description, including animation, video, audio, art, photos, apps, and games.

FIG. 3 shows a base display for a digital source, in this example a typical digital activity book or worksheet, that requires student input in written form. The outer frame 301 is the same as 201, and it contains the activity book layout and content 302. Items denoted by 302-312 are all commonly found in worksheets and activity books. The first input fields have labels 303, 305 and editable single line fields 304, 306. The activity number 307 designates the educational sequence of a worksheet within a larger activity book or curriculum. The work type designation 308 describes the type of work and the title 309 shows the topic. Examples of instructions are found in 310 and 311. The student inputs an answer to question 311 in the multi-line editable text area 312. The editable items 304, 306 and 312 allow the user to add, delete, and alter the text in the standard way computer forms work. The scrollbar 313 enables the user to see different parts of the content 302 as is customary in common user interfaces (UI). As with FIG. 2, the digital source navigation could also be implemented by other means.

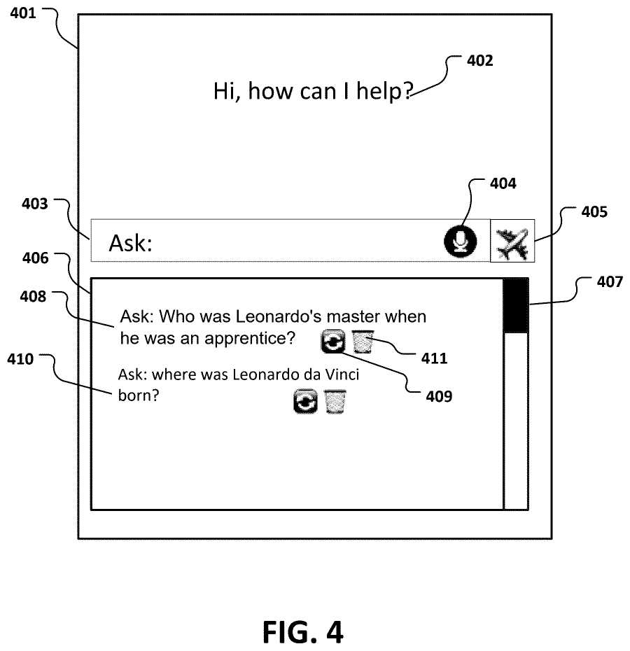

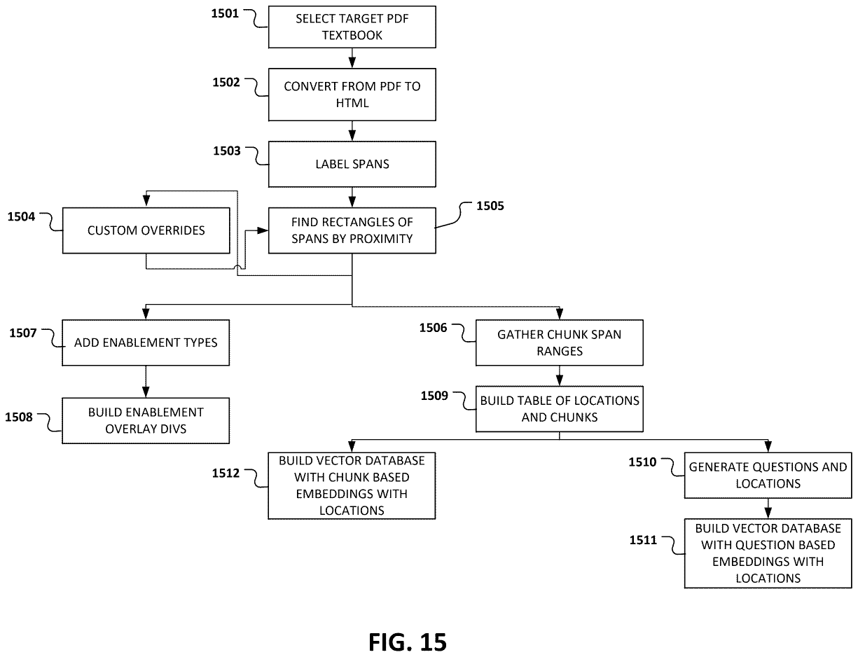

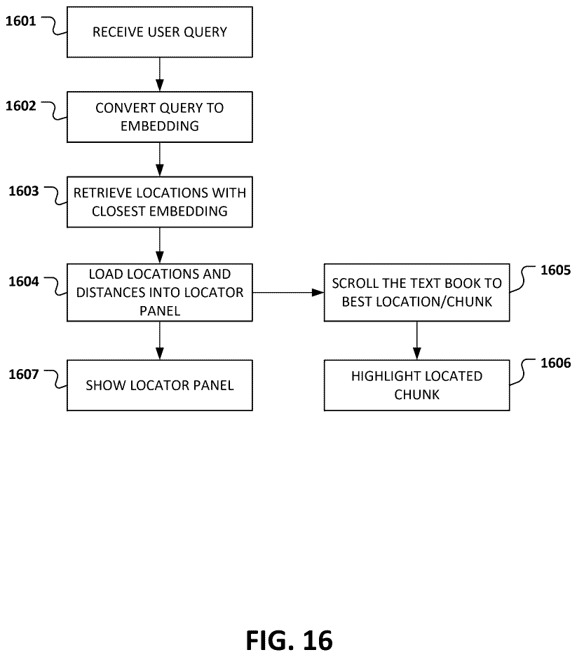

The locator components include the search module, which utilizes AI-driven search with some sort of language processing to identify and retrieve relevant sections of the digital source, based on user queries; the nav module, which provides visual indicators, such as highlights, to direct the user's attention to the retrieved content; the query panel, which displays a list for the chunk-set, and the locator configs. FIGS. 4 through 8 illustrate the implementation of the locator, and with enhancement that would only be visible if the enhancements toggle is switched on, as shown in 509, 1009, and 1114. The process for building and using the invention's unique search mechanism mentioned above, is explained in detail with references to FIGS. 15 and 16.

As with many AI interfaces, query panel 401 shown in FIG. 4, encourages the user to write a query, and prompts for an action. However, unlike other AI systems where the action consists of generating a textual or visual answer served up to the user, the search module begins the process whereby the locator finds a chunk-set containing the information a user needs to answer their own query. Without the search module, the student traditionally needs to skim read the different materials to find the answers. The locator addresses the challenge of skim reading for some populations and in some instances, a need described above. Instead of relying on skim reading as the only method for finding an answer to a query or offering a keyword search that is not useful in all instances or providing an answer, the locator delivers a pertinent chunk-set so the user can determine the answer in a focused, expeditious manner.

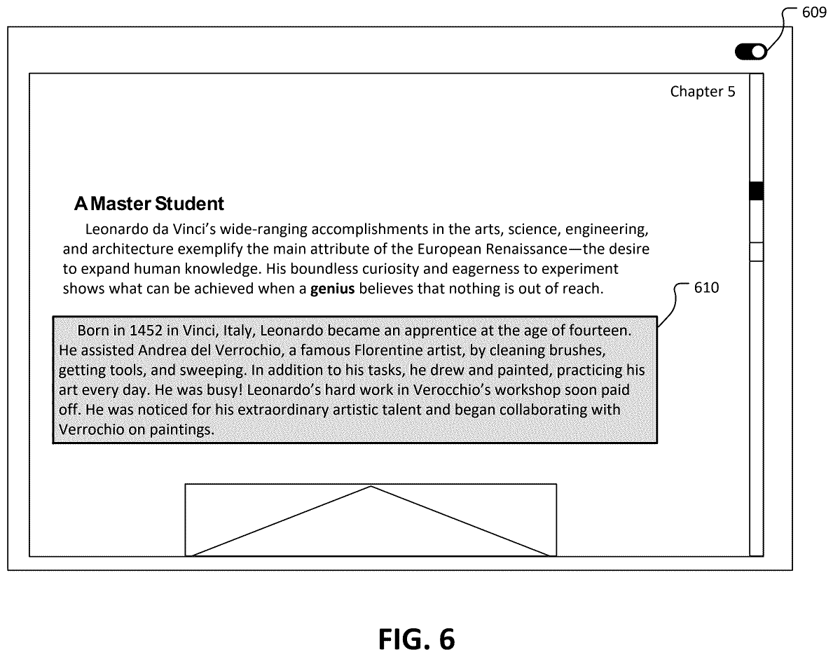

In FIG. 4, the locator shows the query panel 401 ready for user input. The user queries the locator by text 403. After inputting the query, the user presses 405 to send it to the locator. After the locator receives the user's query, the search module retrieves the chunk set locations. The locator's nav module scrolls to and highlights the first location in the digital source set where the answer could be found shown in FIG. 6. The nav module also displays the mini-panel, shown in FIGS. 7 and 8, with the list of pertinent chunks. The list of the chunk set locations where the user could access or infer the answer to the query is activated in mini-panel 701 and shown in the dropdown of the mini-panel, 808. These chunks, which are responses to the query, provide the support the learners need to be able to answer their own query.

FIG. 4 includes History Section 406 that shows previous queries from the session that can be asked again by clicking 409 or deleted by clicking 411. Clicking 409 will result in the same response as the first time 403 was given the query. The full history of the session can be shown by the user moving the scroll bar, 407, up and down as per usual for digital scrolling or by navigating with another method, with the most recent query at the top 408. Older queries are represented by 410. The purpose of communication message 402 is to welcome the user, and could present something other than text, such as icons or animations. Through an application programming interface (API), the communication message may include custom information, such as a user's name, the date, their class, and progress in the book.

The clickable microphone 404 is only relevant to the combination of locator and enabler and is explained below as part of the combination. When the locator function is used without an enabler, it is not shown.

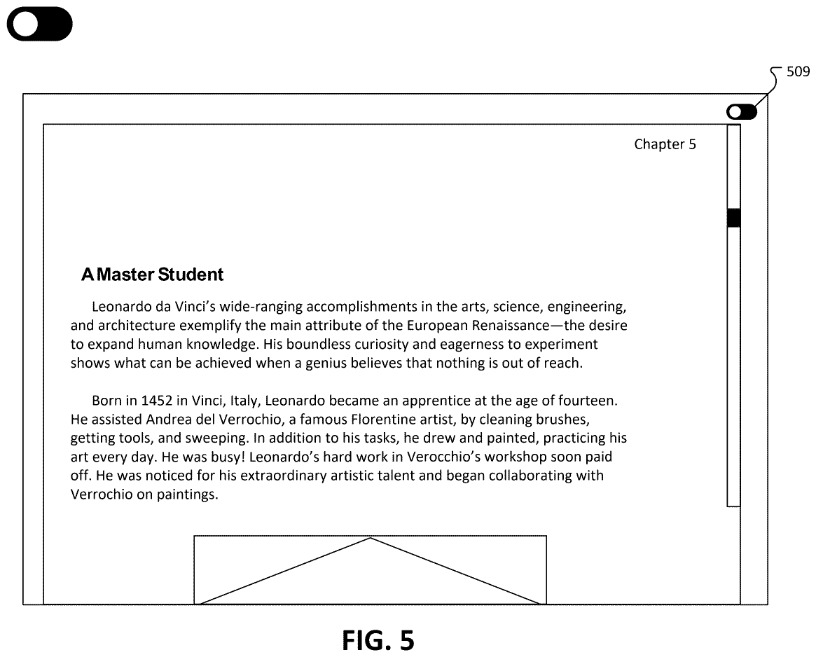

Once the query has been entered in field 403 of the query panel and sent 405, as described above, the system will display the relevant chunk shown in FIG. 6. In the display of FIG. 5, the enablements switch 509 is OFF. The text is displayed without any enhancements.

In contrast, the display of FIG. 6 shows the results when the enablements switch 609 is ON. With the switch on, the display now includes an enhancement of highlight as shown in paragraph 610. In addition, the mini-panel in FIGS. 7 and 8 shows the results, and the nav module scrolls to the first location and highlights the chunk as shown in FIG. 6. The search module may return a chunk, or a chunk set with chunks from multiple sources from the digital source set in the walled garden. The mini-panel allows the user to access the locations, as shown in FIGS. 7 and 8.

The example query that has been sent to the locator is shown in 408, “Who was Leonardo's master when he was an apprentice?” The response from the locator is shown by the highlighted chunk in 610, highlighted in FIG. 6, and shown without highlighting in FIG. 2 at 206.

As shown in the above example, the query response is a pertinent location in the digital source set. The student must read the chunk to ascertain the answer. Unlike current AI systems, which would respond with a sentence naming Leonardo's master, these embodiments do not supply the answer itself. Therefore, the student cannot plagiarize an AI answer. This distinction addresses the issue of cheating with AI by copying and pasting or paraphrasing from source materials outside of the walled garden.

Unlike prior art searches in the educational context, the locator combines a walled garden, digital source set with an immediate, location-specific, first response to a query. The user does not have to initially look at a list and click to see results or be served up a snippet from an answer that must be clicked to be seen in full. The user is automatically shown the first result, which is highlighted, in the base display or base display set discussed in more detail below in the flowcharts. Additionally, that and other results are from the vetted contents of the digital source set. For some potential users of the embodiments, this ease of use, efficiency, and reliability of information are paramount.

FIG. 7 shows a movable mini-panel 701 with multiple controls, with the drop-down shown in FIG. 8. The mini-panel of FIG. 7 can float above the base display shown in FIGS. 2, 5, or 6, after the locator components have been activated by the user sending the request in FIG. 4 at 405 and the pertinent text, the chunk, has been highlighted 610. By interacting with FIG. 7, and optionally FIG. 8, the user can access the locations in the base display that hold the information needed to answer the user's query. FIG. 7 can be moved above, below, or to either side of FIGS. 2 and 3. The X button, 702, closes the mini-panel 701 of FIG. 7. The first part of the user's most recent query is shown in 704, and the full query can be shown by hovering over 704, not shown. Clicking 703 opens FIG. 8, the pull-down menu with all pertinent responses to the query.

The mini-panel is small and movable so that it does not interfere with the digital source or, when used in combination with the enabler, distract from the enabler display. The user can navigate through the chunk set without opening 808. To move to the previous chunk provided as a response to the query, the user presses 705, and to move to the next chunk provided for the query, the user presses 707. Label 706 shows the relative position of the current selection. In response, the locator, described in full in FIG. 16, will show the section of the digital source, often a page, which contains the previous or next chunk. The locator will highlight the chunk. A frame or holding device for media without text can be highlighted if it contains a textual description that fits the query. This additional highlighting function is not shown in this document.

FIG. 8 shows the mini-panel of FIG. 7 with its interactive pull-down menu 808 listing the locations of the chunk set generated by the search module after a user query was invoked in the query panel in FIG. 4. The chunk set and digital source set, determined by the search module and locator respectively to contain pertinent chunks and information for answering the query, are sorted by applicability. FIG. 16 describes an embodiment of the method. Locatable chunks that have been displayed and highlighted will be shown by checkmarks, 811. The current location is shown by 809, in this instance the page citation is bold, and the content in the currently highlighted chunk is the pertinent text, 610 in FIG. 6. The user is getting ready to click page 28, which is why the hand shows as the cursor 812 and page 28 is highlighted 810. When the locator opens page 28 and highlights the pertinent text, as shown at 610 of FIG. 6, the page number in the pull-down menu will be shown in boldface, and there will be a checkmark. It will no longer be highlighted. The user can click any listed location, 809 and 810, with the cursor, 812, and the locator will show and highlight it.

Finally, regarding the locator, the locator has a variety of configurations, locator configs that apply to different settings for students, teachers, and editors that can be customized. Example settings include, but are not limited to, the number of items and sort order in the chunk set shown in the mini-panel, the scope of the search (page, chapter, digital source set), individual locator chunk definition overrides discussed below, and type locator vector database, discussed below.

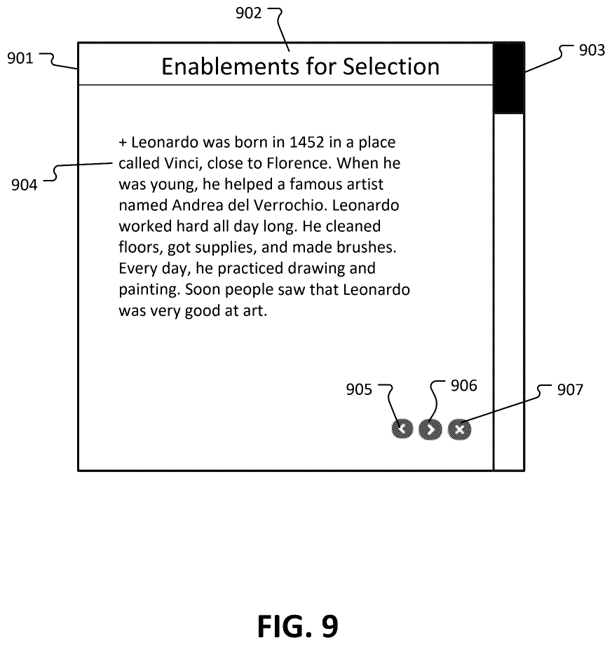

The discussion now turns to the enabler and its components. The enabler components comprise the enabler processor, the enabler display, and the enabler configs become active only when the enhancements toggle such as 609 in FIG. 6 is turned on, unlocking a set of useful features. The enabler can be toggled on/off using 609. Once toggled on, the enabler processor dynamically and seamlessly applies enablements in an enabler display, such as FIG. 9, floating over the base display set. This application enhances the highlighted chunk 610 shown in FIG. 6, making the content easier to understand and allowing the user to focus on one chunk of content at a time.

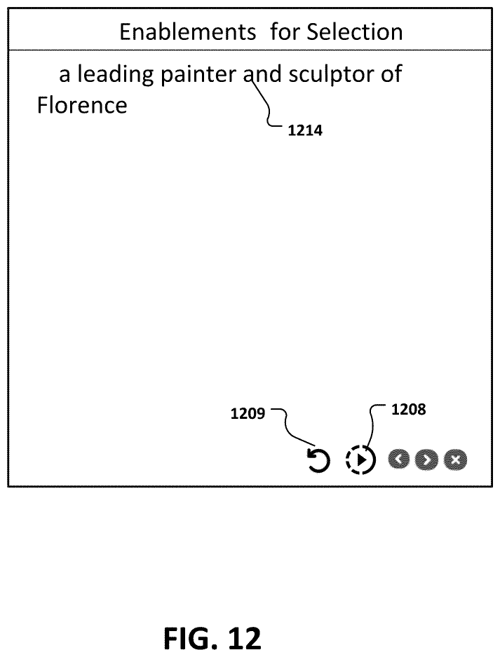

The enabler's use of the enabler display in FIGS. 12-14 while maintaining the same base-display that all the students in the same class see, addresses the need for communicating to the group cohesively without users needing to manage a panoply of software tools.

The embodiments herein use English as the base language and deliver a variety of enablements, both read accommodations and write accommodations. These accommodations assist readers and listeners in understanding the digital source and assist with communication needs for those who do not type in the base language. In the examples here, reading accommodations and writing accommodations require variations of the enabler processor and enabler display. The examples of the embodiment here also implemented combinations of some of the enablements, such as simplified language followed by Spanish, creating simplified Spanish. Any language could be used as the base language.

As previously discussed, FIG. 6 shows the base display and the digital source with an enabled chunk 610 that was clicked on and thus temporarily highlighted. This action causes the enabler processor to bring up the enabler display shown in FIG. 9 or 12, depending on the enablement. The enhancements toggle 609 in FIG. 6 is in the on position, as compared to 509 in FIG. 5, which is in the off position. When the toggle is in the off position, the chunks would not react to being clicked.

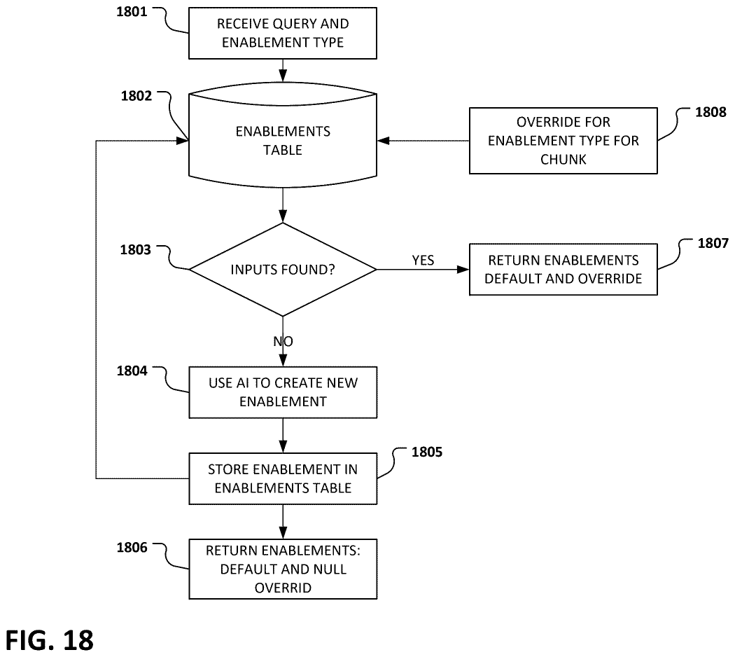

FIG. 9 illustrates the enabler display 901 driven by the enabler processor. The enabler display is movable, so the user can see the digital source unobstructed with the chunk in context. Because the digital source is unobstructed, the user can refer to it while using the enabled version of the text. The enabler display contains a title bar 902, which can be used to drag around the display if it is not a fixed panel, and a scroll-bar 903 for use when the enabled text 904 is too large to fit in the display 901. The enabler processor prepares the resulting enabled text 904 in two flavors, an AI-generated accommodation or a human override, which is null by default, discussed further with regard to FIG. 18.

The enabler display, which can be a movable dialog box of FIG. 9 located near the highlighted chunk to which it corresponds, a fixed side-panel or some other type of display. For example, it could comprise a tool-tip that activates on mouse down or hovering. The enabler display appears when the user clicks an enabled chunk in the base display. Chunks that can be enabled vary according to the digital source and the particular enablement, as described in greater detail below.

When the user presses 907, the enabler display 901 closes. The enabler display has a “previous” 905 and a “next” 906 button. These buttons load the next or previous enabled chunk at the same time they show the corresponding digital source in the base display. The “x” button 907 closes the enabler display. As explained above, it is important to focus on one chunk of content at a time, and the navigation buttons 905 and 906 allow the user to easily access the enabled chunks sequentially. As shown in FIG. 18 and explained below, the enabled chunks are converted to enabled versions efficiently.

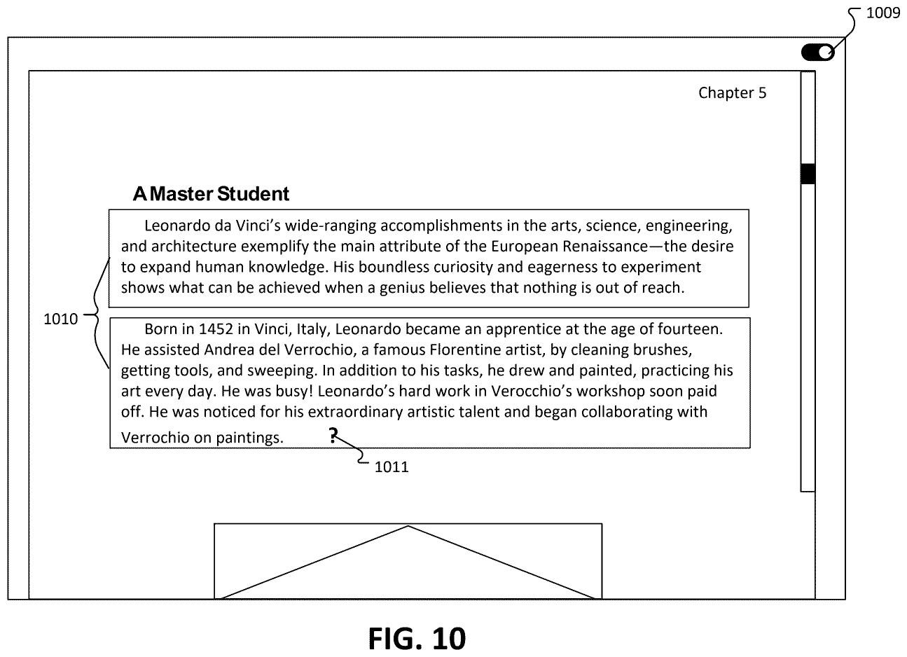

FIG. 10 illustrates the base display with enhancements toggle on and the digital source with outlines 1010 showing enabled chunks. These outlines, 1010, can be shown or hidden by the user, according to settings of the enabler configs. The enabled chunks, identified by outlines 1010, vary according to the particular enablement. Even without the outlines, if the user is allowed enablements, question mark 1011 appears as an overlay on any chunk 1010 when it is clicked. Depending on the enablements personalized for the user, as described in the enabler config either FIG. 9 or FIG. 12 will appear when the user clicks the cursor while it displays the question mark, 1011.

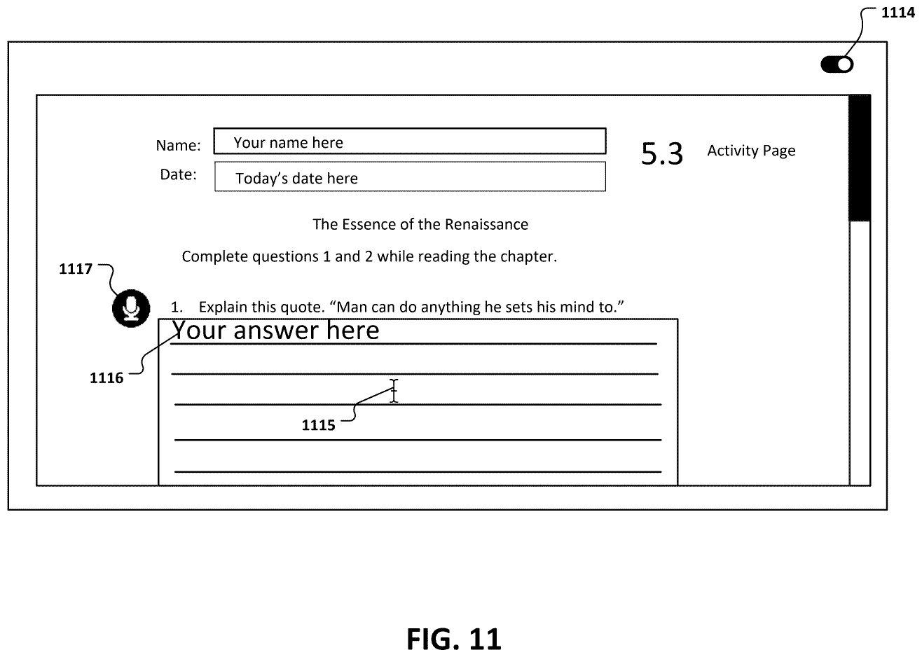

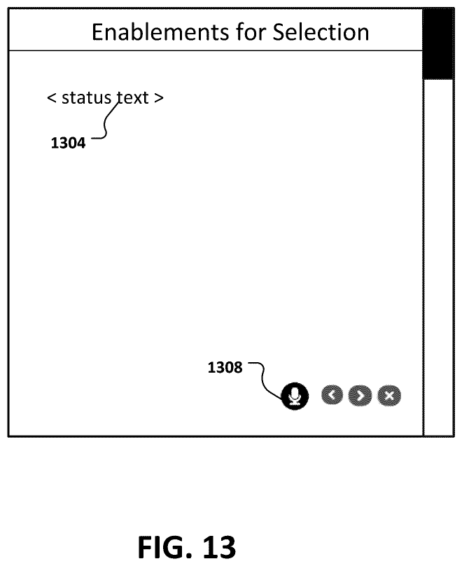

FIG. 11 shows how speech-to-text can be invoked by the user. This writes accommodation supports users who cannot type but can dictate. If the speech-to-text enablement is assigned for the current user, the microphone icon 1117 will be shown next to an editable field when the cursor 1115 clicks in that field. When clicked, the editable field entry point, 1116, begins blinking. The user can interact in the standard way with an editable field such as 312 in FIG. 3, or they can click on the microphone icon, 1117, to bring up the enabler display and start the recording. Once the recording starts, the microphone icon changes color to red, or changes form to “stop recording” icon, not shown. Clicking on 1117 will also automatically show the enabler display shown in FIG. 13.

FIG. 12 presents the same enabler display as shown in FIGS. 9, 13, and 14, but FIG. 12 illustrates the read-to-me enablement. The displayed text 904 of FIG. 9 is replaced with dynamic text 1214. The text shown, 1214, matches the phrase currently being read aloud, synchronized with the speech being played. Label 1208 shows the speed control that slows or speeds up the voice that reads the highlighted chunk, such as 610 from FIG. 6, aloud. Control 1209 replays the speech and synchronized phrases from the beginning of the chunk.

FIG. 13 displays the same enabler display as shown in FIGS. 9, 13, and 14, but FIG. 13 illustrates the speech-to-text enablement for user input. It appears when the user clicks the microphone icon 1117 in FIG. 11. Label 1308 displays the microphone icon, which begins recording when clicked and opens FIG. 13 with status text 1304, and includes a reinforcement of what the recording icon shows. It instructs the user to click the microphone and indicates when the user's recording commences. Once the recording starts, the microphone icon changes color to red or changes to another icon that indicates that it is the stop-recording button (not shown). FIG. 13 launches once the user stops the recording by pressing the version of 1308, which is the stop-recording button. Status text 1304 informs the user of their current stage in the process of recording. The sequence of messages is as follows. First, the user clicks on the record button and the status text says, “Starting recording . . . ” then “Recording . . . ” and “Done Recording . . . ”.

The status text 1304 applies to the speech-to-text-2 enablement, but for speech-to-text-1, since the user cannot read, the status text would be augmented or replaced by icons, illustrations, animations, or other media. Likewise, if the enablement combines speech-to-text-2 with a translation, then the status text needs to be augmented or replaced with a translation of the status.

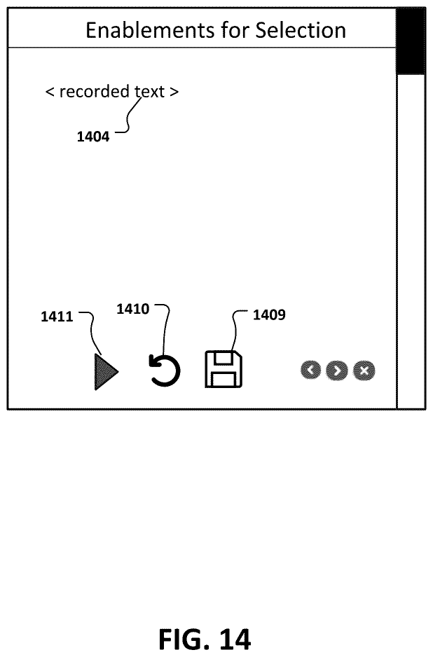

FIG. 14 displays the same enabler display as shown in FIGS. 9, 12, and 13, but it shows the review function of the speech-to-text enablement. This enabler display is included in the sequence that begins with FIG. 13 and is followed by clicking the microphone 1308. When the user is finished with the recording, the user again presses 1308, which was changed to red while recording was in progress. The transcription of the user's recorded speech is shown by 1404. It is presented for a speech-to-text-2 user, so they can review it before inserting it in the targeted editable field 312 in FIG. 3. They insert it by clicking 1409.

For a speech-to-text-1 user, who cannot read the transcript 1404, the button 1411 uses the read-to-me enablement to read the transcription aloud to the user. This read accommodation, when applied to the latest recording, does not replay the recording just made by the user. The reason that the recording is not replayed is that it would not capture any errors in transcription. It reads aloud the transcription to allow users to review the accuracy of the transcription before deciding to put their typed answer or other input into editable fields, such as 312 in FIG. 3. If the user decides the answer should be added as typed text to field 312, the user presses 1409. If the user determines that the recording or transcription are not acceptable as an answer to the editable field 312, they can press the retry icon 1410 to delete the recording and return to FIG. 13 to record again.

The recorded speech shown 1404 may be augmented for combined enablements that include a translation enablement. Item 1404 may present both the speech-to-text result, which is not in English or other base language, and the base language version.

As mentioned above, the enabler configs permit adjustments to the enabler settings. For the base display settings, the outlines 1010 in FIG. 10 can be shown or not. The set of enablements could be chosen by approved admin users, such as teachers or school admins, for each student; the choices being selected individually or according to official classifications of allowable personalized accommodations. Another possibility for the selection of enablements would be to let the students or parents choose them, or they could be selected by the current user for the session. The set of enablements for a particular user can be changed over time as the user's need for the accommodations decreases or varies. Additionally, there may be enablements that should be applied to different groups of users, or globally. The overrides for individual enabled chunk definitions are discussed regarding FIG. 15, or enablement conversion, the output, discussed in FIG. 18 that can be entered by editors.

Having set out and shown the operations of components of the system and the relationship between them, the discussion now turns to embodiments of methods used to implement the components.

FIG. 15 shows the converter process to prepare a closed format, in this case PDF, textbook to an open, tagged form, in this case HTML, which includes the locator and/or the enabler metadata. It shows the steps needed to make a PDF source into a base display-ready digital source. An open-tagged format comprises any format in which portions of the text are tagged with an index or other indicator of the content.

The converter processes all the materials in the digital source set. Each individual document is selected at 1501 and converted separately into the custom format. This example uses PDF textbooks because of the prevalence of this format.

The converter processed the PDFs, delivering HTML to facilitate the coding. Products are available to make these conversions. In one embodiment the converter at 1502 outputs ordered and labeled, or tagged, spans 1503, simplifying subsequent coding. This process may be achieved with many other methods, and could be applied to other formats (EPUB, kindle, etc.). The converter at 1502 converts all the text items to spans 1503 and generates numbered HTML pages. The IDs of the spans include the page numbers. The example here focused on text items, so the focus was on spans. If an implementation were to include images and other elements, the conversions would have to convert to portions of those like spans.

The process looks at the placement of the spans at 1503, and groups them by proximity and location on the page. This process works well, but on occasion some span groups may require alteration, for example because they were misidentified as belonging to the same chunk, and/or there were overlaps of the bounding boxes, so the process allows custom overrides at 1504 for such corner cases.

Once the spans are correctly identified, the process finds rectangles of spans by proximity at 1505. The finding of the rectangles at 1505 may have two results. First, the process gathers a list of span ranges that belong to the same chunk at 1506, which can be used for the locator. Second, the process adds the enablement types at 1507 that result in a list of overlay divs at 1508 used by the enabler. The term “div” applies to HTML, being short for “division,” meaning a container for grouping HTML elements. If another type of open, tagged, file format is used, the equivalent term would be used there.

Returning to 1506, a table of chunks versus locations, span ranges, is built at 1509. This table can be used to build a vector database, such as 124 from FIG. 1, containing embeddings-vs-locations 1511 or 1512.

One embodiment uses text from the chunks in 1506 to create a vector database 1512 containing chunk embeddings versus locations. The building and use of this vector database is discussed in more detail below regarding FIG. 18. Another embodiment generates questions with locations using AI to build a vector database 1511 containing question-embeddings-vs-locations. The building and use of this vector database is discussed below.

Regarding the two embodiments shown for the vector databases, the locator can enhance the embeddings creation by processing the input text to ensure the embeddings are based on full phrases with better context than just the span text. In some embodiments, the input text may be processed with NLP tools, or by a generative AI transform, among other possibilities. However the embeddings are built, the processing of the user input will benefit if the search module pre-processes it with the same tools before doing a similarity search.

In the case of enablements, the converter needs to add enablement types 1507, which can be assigned to each enablement overlay div 1508. Some enablements are not appropriate for all chunks, such as “Chapter 3”, which does not need to be enabled for a user who needs simplified language but should be translated for a user who has need of a translation enablement. There may be other reasons for specializations, and some users may access digital source set content that is enabled in multiple ways. In an embodiment, the core enablements include, but are not limited to simplified language abbreviated ‘l’ (for language), Spanish or Chinese abbreviated ‘s’ or ‘c,’ read-to-me abbreviated ‘r,’ and speech-to-text abbreviated ‘m’ for microphone.

As shown above, the embodiment of the enabler, assigns the first letter of the enablement type. As an example, the converter can add data such as providing the input el=“lscrm”, to the enablement divs in the HTML code for all accommodations, as an example. A second example would be if simplified language were not needed, the divs for chunks would be data-el=“scrm” as an example. The converter also has an enablement for ‘record’, but that one is only applied to editable fields, so in this embodiment it did not need to have an enablement type.

The execution of the process for steps 1504, 1505, 1506, 1509, 1510, 1511, 1512 may be executed at production time, and the vector database would typically be stored in an external database on a server. Although it would be possible to store the vector databases on the user's computer. Another embodiment can execute some of these steps at runtime, caching results for future sessions and/or users. Similarly, the execution of steps of the enabler 1504, 1505, 1507, 1508 can be executed at production time, and the updates to the HTML could be stored directly in 1503, or the updates could be stored in a server database and applied at execution time to 1503. The custom overrides 1504 and the enablement types 1507 could be developed at production time by the publisher or by the implementor, or at execution time by the school, the teacher, or the student.

The person allowed to make adjustments depends upon the rights assigned to the user. The ability to separate the enablement customizations from the original HTML at 1503 allows for some useful configurations allowing avoidance of copyright and privacy issues. In some implementations, the original HTML can be kept on the owner's system(s), and the external server contains no original content, and the original HTML is useful on its own. With this implementation, textbooks that have some versions of CC licenses can be released by a non-profit corporation, and then the additional enabler capabilities can be supported separately for a fee.

The locator and enabler metadata and the embeddings do not contain enough information to be usable without the original, converted digital source set. A third party can offer a privacy and copyright protection setup where the metadata and embeddings can be stored on a server that is of little value without the converted HTML. The enablements are derivative works that may contain enough information to approximate the original PDF, but they cannot replicate the identical original material.

FIG. 16 shows an embodiment of the locator operation at execution time. The user interface is shown in FIG. 4. The user enters the query, and the system receives the query at 1601. The system converts the query to an embedding at 1602.

The use of embeddings differs substantially from traditional Retrieval Augmented Generation (RAG) based chat applications. Because the embodiments only seek chunk locations, and not a carefully composed chat answer, the embodiments can use the same embeddings in a more efficient way or even use different embeddings. A typical RAG chat produces chunk-based embeddings from the chunks' text. When a query is processed, it is converted to an embedding and compared with the chunk-based embeddings. The text from the top few matches is attached as context to the original query and passed on to a large language model (LLM) to provide an answer.

To get locations of relevant chunks, a suboptimal implementation could use the above-mentioned RAG technique as long as the embeddings included chunk locations. Since the embodiments have no need for the LLM answer, they could skip the LLM call, saving substantial time and resources. Furthermore, the embeddings do not need the chunk text either, saving substantial space. The chunk-based embeddings described here are shown in 1602. The accuracy of the matches improves if the query is answered first by an LLM, and the answer is converted to an embedding to be compared with the chunk-based embeddings.

Another embodiment for embeddings consists of making question-based embeddings of potential queries with the locations of the chunks that answer said queries. Then the user's query is converted to an embedding and compared with the question-based embeddings returning a set of locations. The chunk-based embeddings described here are shown at 1511 in FIG. 15.

Returning to FIG. 16, when the user enters a query at 1601, whether typed or dictated, the system converts the query to an embedding 1602. Embedding 1602 may be generated by either converting the query to an embedding compatible with 1511 or first answering the query using AI and then converting the answer to an embedding compatible with 1512.

Next, at 1603 the system retrieves the locations of similar embeddings, to the embedding 1602, in one of the vector databases 1511 or 1512, both of which are represented by database 124 in FIG. 1. At 1604, the system loads the results from 1603 into the location panel. The best location for answering the query is used to scroll the book or digital resource so the chunk at the location is visible at 1605, as shown in FIG. 6, and then the chunk is highlighted at 1606. Simultaneously, the system shows the locator panel at 1607.

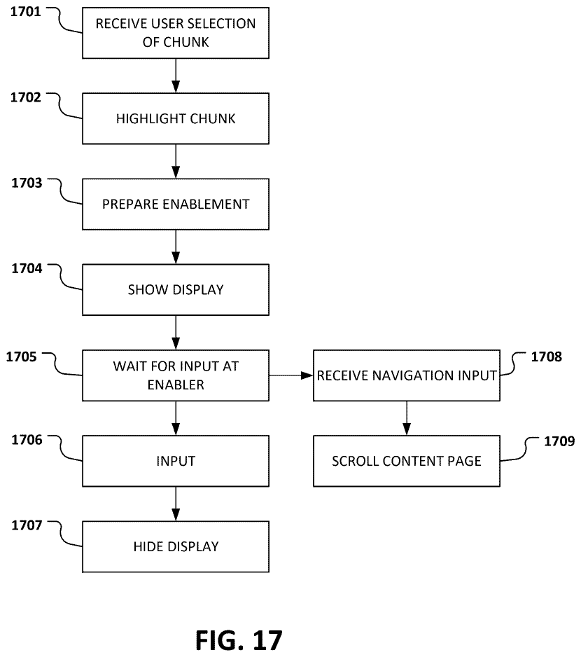

FIG. 17 shows a flowchart of a method of the enabler. When the system receives a user selection of an enabled chunk at 1701, the system highlights the chunk at 1702, and then prepares the enablement at 1703, as will be discussed with regard to FIG. 18. Then the system shows the enabler display at 1704.

Next, the enabler display waits for input at 1705. If the user chooses to close the display at 1706, the display is hidden at 1707. In this case, the highlighted chunk in the digital source is reverted to the original digital source, as in FIG. 5, but with the enablement toggle 509 in FIG. 5 unchanged. If the user chooses a navigation input 1708 (which could be the previous or next enabled chunk), the content page scrolls at 1709, so the desired chunk is visible, and then goes back to step 1702, and repeats the cycle.

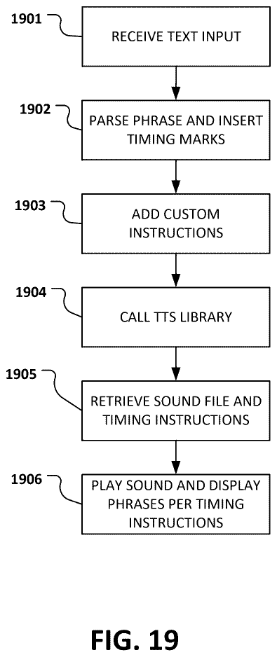

The dynamic enablements of read-to-me and speech-to-text have additional controls and flow changes. The read-to-me enablement adds two icons for re-playing the speech as shown at 1209 in FIG. 12 and adjusting the speech speed 1208. For this enablement, 1704 is replaced with a dynamic display while the speech phrases are being played, as described below with reference to FIG. 19.

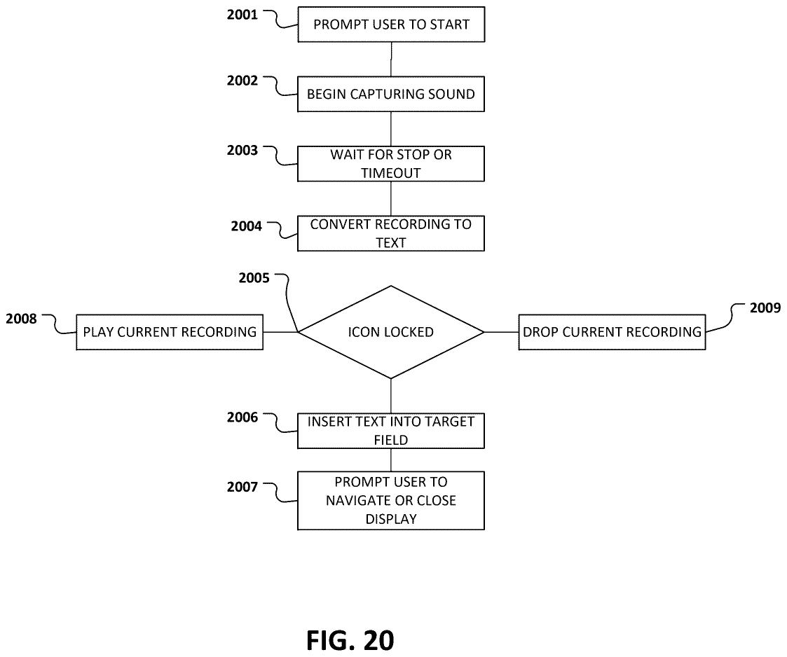

The speech-to-text enablement is invoked, shown in FIG. 11, by replacing 1701 with an interaction of an editable field and an icon. Instead of selecting an enabled paragraph at 1701, the user hovers over an enabled field such as 312 in FIG. 3, the cursor changes to an I-beam cursor such as 1115 in FIG. 11, and when the user clicks in the field, a blinking insertion line 116 shows where any keyboard typing will be inserted. When the user clicks, a microphone icon 1117 shows up next to the field, showing that this field supports the speech-to-text enablement. When the user clicks on 1117, the system highlights field 312 from FIG. 3 and the enabler display is presented. The operation of the enabler display is discussed below with regard to FIG. 20, for the speech-to-text operations while step 2007 consists of steps 1702-1709.

FIG. 18 shows an embodiment of the enabler processor workflow, which involves on-the-fly use of AI to generate enablements with enhancements for efficiency and human customization. In one embodiment, a server has a cache of previously processed enabled chunks consisting of a table of previous enablements for given chunks 1802. The records of 1802 contain an embedding of the original chunk and enablement, and an override enablement 1808, which may be null.

When a query 1801 is received, the system searches the store 1802 and processes the result at 1803. If the query succeeds, then the retrieved record 1807 is returned. However, if the query fails, an AI module creates a new enablement at 1804, and stores it at 1805 in the enablements table that was accessed at 1802 and returns the new enablement with a null override enablement 1806.

Editors or other identified users can create overrides at 1808 for individual records of the enablements table accessed at 1802. The embodiment has a single override that does not distinguish the source. In some embodiments, the enabler processor tracks source metadata, allowing multiple overrides by different types of users, such as editors, teachers, students, et al. The enabler processor could also keep track of override dates.

FIG. 19 shows the enabler processor and enabler display handling of read-to-me input text, enabled chunk, modifications to support showing a phrase at a time during playback and other added customizations. In embodiment processes the input text 1901 is split into phrases (looking for commas and periods) 1902, adding timing marks that the text-to-speech (TTS) 1904 library understands, instructing it to return the timings for those phrases. Future implementations can also add customized instructions 1903, telling 1904 how to pronounce certain words, for example, for words that are acronyms or have special pronunciation. A dictionary of replacements can be set up for well-known words, as well as specific words in the text an editor, a person, or a process, deems to need pronunciation corrections by listening to all the input chunks and flagging needed corrections. When the TTS library returns the sound and timing instructions at 1905, the enabler code 1906 in the enabler display simultaneously plays the sound while displaying the phrases at the correct time as shown in item 1214 of FIG. 12.

FIG. 20 shows the speech-to-text interactions in the enabler display for speech-to-text functionality, shown in FIGS. 13 and 14. At first the user is instructed to start the recording 2001 by the status text 1304 and then clicks on 1308 in FIG. 13. Then the system captures the sound until the user clicks on 1308 from FIG. 13 a second time or a certain time period is exceeded at 2003. At this point, the microphone is hidden, the converted text at 2004 is shown by the recorded text 1404 from FIG. 14, and three new icons appear as shown in FIG. 14. The system waits for the user to press one of them, as shown in 2005.

The prompt 2001 may need to be varied for different enablements. For the speech-to-text-2 enablement, the enabler uses status-text. If it is combined with a translation enablement, it will need to be altered, showing the translation and possibly the original status-text in a language other than the base language. For speech-to-text-1, where the user cannot read, a pictorial, video, or animated representation could be provided.

From 2005, the most common path is to insert the converted text 2004 in the target field 2006, such as 312 in FIG. 3. It is worth noting that the text will replace the selected text in 312. If it is an insertion point instead of a selection it will simply insert the text. Finally, at 2007, it updates the status text 1304 from FIG. 13 to prompt the user to press the standard navigation buttons 905, 906, or 907 in FIG. 9, to make the UI respond.

A second option from 2005 consists of playing back the recorded sound 2008 to see if it adequately represents what the user intended. This is particularly necessary for speech-to-text-1, where the user cannot read and thus needs to listen to the recording.

A third option from 2005 allows the user to re-record by deleting the pending recording at 2009. This allows the user to iterate recording until they are satisfied with the result before writing to the target field 2006.

A combination of the two enhancements provides students with powerful support for learning at the same time it preserves the original material. Many students will benefit from the locator alone, while students needing accommodations will find the enabler works seamlessly with the locator. When users have a query, the combined components empower them to figure out the answer on their own with support. The combination leads learners to the pertinent location(s) where the answer can be found and enables their understanding of the information so they can answer their own query. This is accomplished not only by the methods described in this patent but also through providing a user experience that supports learning and addresses the issue of increased cognitive load.

The educational methodology behind the design of the UI prioritizes empowerment and ease of use. The presentation and interaction are consistent for both the locator and enabler. The floating displays are consistent. The mini-panel for the locator is shown in FIGS. 7 and 8. The enabler display for the enabler is shown in FIGS. 9, 12, and 13. This consistent and familiar UI minimizes the burden on users, so they can focus on learning.

Improved focus is also behind the synergy of the enabled chunk and the locator's use of the base display. The combination locates and enhances the information in chunks so challenged users will not be overwhelmed. The base display provides context for an enabled chunk by making the entirety of the source material (digital source set) available and easily accessed.

In this manner, the combination of the locator and enabler has a variety of configurations, the locator configs and enabler configs. The difference between the combination of the two compared to using only one is that they may be presented as a single set of configurations without distinguishing them as separate categories, but rather just a single list of enhancements, to bypass the stigma of needing special accommodations. Also, the enhancements toggle may apply to both, or there may be separate toggles. Lastly, if the option of toggling the enhancements off is not deemed valuable, the enhancements toggle could be omitted altogether, and different students could see variations of the enhancements.

The embodiments here provide a novel approach to enhancing digital content, including books and other media that can be described in text, by combining intelligent content retrieval from within a walled garden with adaptive accessibility overlays, all while preserving the original book's presentation through a common base display. This integrated system enhances student comprehension by providing approved support and retaining the requirement of students to think, respond in their own words, and learn.

The applications for the system disclosed above extend well beyond the educational context. As mentioned above, the locator and the enabler, alone or together, have many applications, including that of a web, or content, browser. The use of the term “web” may imply that the content is on the Internet, but the locator and enabler may interact with all sorts of digital content, such as a company's intranet, a defined digital library of an organization's or user's creation, etc.

In some embodiments, the user may define their own walled garden by designating certain websites, such as professional or academic journals covering particular subjects, sources of information that the user believes to be credible, etc. Alternatively, the user could designate the top five locations identified by a Google® or other search as being “safe” and can be added to the walled garden of that user. In this context, the resources in the walled garden comprise “selected” resources. The locator, as before, would locate the information the user seeks without providing an answer, serving two purposes. First, the user has the opportunity to come to their own conclusions based upon the information gathered. Second, by not providing an answer, the AI interface would not have the opportunity to produce a hallucinatory answer.

The user's access to resources, their ability to build a walled garden, including the garden's size, may be determined by user characteristics. They may include age, location, preferred language, subscription level, and characteristics of that nature. The enabler could come into usage with the locator as in the educational context, providing the user with the same accommodations discussed above. However, one could use the enabler without the locator for general uses. A user could launch the enabler while using an available web browser like Google Chrome®, an application like Facebook®, newsfeeds, online newspapers, reviews, manuals, etc. The enabler would provide the user with accommodations beyond those currently available with current accessibility features.

The system disclosed herein also provides for several advantages in various use cases. For example, real-time question-answering over large datasets can be costly and inefficient. By pre-processing and embedding question-location pairs, referred to here as QLOC, the system avoids redundant computation during runtime. This significantly reduces energy usage and operational costs while improving performance and speed.

The QLOC capability may not have enough questions that are common to what students or users may ask, so the system may use RAG, which is slower and expends more energy and compute time. After the user's query has not been able to be answered by QLOC, but has been addressed by RAG, the generated question-location pairs are added to the QLOC embeddings of QA pairs. These are added to the QLOC database, improving accuracy, reliability, and collective learning value over time. The expansion of QLOC through the addition of question and answer pairs from RAG increases the probability that future users'questions will be answerable by QLOC, the most efficient method. This addition enables continuous improvement of the database by adding questions outside the scope of the original pre-processed ones.

Issues arise with the accuracy of responses to user queries about academic topics. As of April 2025, ChatGPT has 88% accuracy in answering general knowledge queries, 49% accuracy in answering short, tricky questions, and 59% accuracy in answering questions about public figures and common people-related facts. It should be better. See https://livechatai.com/blog/is-chatgpt-accurate with sources from OpenAI o3 and o4-mini System Card (valid as of Apr. 16, 2025) https://cdn.openai.com/pdf/2221c875-02dc-4789-800b-e7758f3722c1/o3-and-o4-mini-system-card.pdf.

In limited tests of location answers vs. summary answers in a walled garden, location answers have been more accurate. In a test of 204 questions, the summary answers made 5 errors to the walled garden's 2 errors. The reasons for this result are that answer locations do not have bias, including a potentially incorrect opinion expressed in a summary, and do not hallucinate. The response comes directly from the source material. The embodiments will continue to improve accuracy rates by adding more search methods to respond to a prompt and possibly to double-check a location answer from QLOC, RAG, or Graph methods.

The following methods will be used to answer queries. The methods locate a chunk that contains the answer or chunks that together provide a full answer. These methods occur in the following order. Other than QLOC, the first method, each method initiates only if the previous has failed to find the answer location(s). However, the system may use one or more methods to double-check results of an answer to a prompt.

QLOC answers questions that are the same as or similar to those that have been embedded. The embeddings are created using answer locations in the textbook provided by LLMs such as Claude and ChatGPT. When a walled garden has been inputted into the system by a user such as a teacher, publisher, administrator, or student, an LLM is queried to provide questions and answer locations based on the text of each digital source in the walled garden and the walled garden content as a whole. The LLM checks the answer locations against answer summaries according to a set of prompted requirements and then compiles a list of question-and-answer location sets in JSON or similar format, omitting the summaries. The LLM then rewords each query in the list, associating each reworded query with its original query and answer locations. These reworded queries are added to the original list. The list (or lists) of question-and-answer location sets are embedded. These are later retrieved when responding to a user query that resembles a query in a question-and-answer location set embedded in QLOC. This method may be used for familiar or similar queries.

If an answer is not found, a second or any number of multiple subsequent search options may be employed. As described above, the system could employ RAG to answer unfamiliar questions. If an answer is not found, the user is told that the answer cannot be found in the walled garden.

As discussed above, in the educational context, AI summary answers think for the students, which is doing too much, removing the agency necessary for students to learn best. Skimming to ascertain answers to complex questions leads to added cognitive load because the pertinent chunks often cannot be viewed together in a digital source set. The same cognitive load is found in looking at the answer-location chunks one by one as they are presented by the locator. When there are many locations, it can be extremely difficult for a student to hold all the information in their memory at one time, and it is not efficient to assemble the information in one place by typing it out, copying/pasting, or taking screenshots. However, this compilation is needed for students to think through and find an answer to their query.

As with all queries accepted by the tool and mentioned above, a query need not only be a question, it can include a statement. The query also can be a question written as a call-to-action, such as asking the tool to find proof to refute an assertion or telling the tool to create a location-based outline or index.

Embodiments of the disclosure may operate on customized or standardized hardware, in firmware, digital signal processors, or on a specially programmed general-purpose computer including a processor operating programmed instructions. As used herein, the terms controller or processor include microprocessors, microcomputers, Application Specific Integrated Circuits (ASICs), Field Programmable Gate Arrays (FPGAs) and dedicated hardware controllers. One or more aspects of the disclosure may comprise computer-usable data and computer-executable instructions, such as one or more or more program modules, executed by one or more computers (including monitoring modules), or other devices.

Generally, program modules as used herein include programs, objects, components, data structures, routines of programs, etc. that perform particular tasks or implement abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific examples of the invention have been illustrated and described for purposes of illustration, it will be understood that various modifications may be made without departing from the spirit and scope of the invention. Accordingly, the invention should not be limited except as by the appended claims.

1. A system, comprising:
a user interface that presents a query window to a user to allow the user to enter a query;
a walled garden comprising a set of selected digital resources;
a converter to convert any closed-format digital resources in the walled garden to an open tagged format and to segment digital resources into chunks;
an artificial intelligence (AI) contextual search module to retrieve chunk sets comprised of cohesive sets of content from the walled garden;
a locator comprising a locator user interface that allows the user to enter the query and uses the AI contextual search module to locate chunk sets relevant to the query in the walled garden and displays the chunk sets on the user interface without modification of the content; and
an enabler to provide one or more accommodations to assist the user with consuming the content.

2. The system as claimed in claim 1, wherein the locator user interface further comprises an enabler display that allows the user to select or be assigned one or more accommodations.

3. The system as claimed in claim 1, wherein the enabler provides an enablement display comprising one or more of a fixed panel, an overlay, and a movable dialog box.

4. The system as claimed in claim 1, wherein the enabler provides an enablement display that provides the user with user controls to allow the user to select at least one or more accommodations or be shown pre-selected accommodations.

5. The system as claimed in claim 1, further comprising a database for storing digital resources in the open tagged format that have been segmented, either previously formatted or from the converter.

6. A system, comprising:
a user interface that presents a query window to a user to allow the user to enter a user query or choose from a list of common questions;
a walled garden comprising a set of selected digital resources;
a converter to convert the digital resources in the walled garden from a closed format to an open tagged format;
an artificial intelligence (AI) contextual search module to retrieve chunk sets comprised of cohesive sets of content from the walled garden; and
a locator comprising a user interface that allows a user to enter a query and uses the AI contextual search module to locate chunk sets relevant to the query in the walled garden and displays the chunk sets on the user interface without modification of the content.

7. The system as claimed in claim 6, wherein the converter converts the digital resources by:
identifying ordered and labeled spans in the digital resources;
grouping the spans into span ranges;
locating rectangles of spans by proximity in the digital resources;
generating chunks from the rectangles of spans;
building a table of chunks and corresponding chunk locations;
building one or more vector databases based upon chunks and chunk locations; and
storing the one or more vector databases.

8. The system as claimed in claim 7, wherein building the one or more vector databases comprises adding chunk locations and corresponding chunk related text into vectors, saving the vectors to the one or more vector databases.

9. The system as claimed in claim 7, wherein building the one or more vector databases comprises:
generating a set of questions and locations corresponding to chunks related to questions in the set of questions; and
embedding the questions and locations into vectors to build the one or more vector databases.

10. The system as claimed in claim 7, wherein building the one or more vector databases comprises:
collecting user queries and locations of chunks located in response to user queries;
embedding the user queries and locations into vectors; and
updating the one or more vector databases.

11. The system as claimed in claim 6, wherein using the AI contextual search module comprises:
converting into a vector; and
use the one or more vector databases to compare to user queries to locate chunks.

12. The system as claimed in claim 6, further comprising a user override to edit and correct identification of spans.

13. The system as claimed in claim 5, further comprising locator configurations to configure settings for the locator.

14. The system as claimed in claim 13, wherein the locator configurations include configurations based upon role, age, access to chunks, numbers of items, sort order, and search scope.

15. The system as claimed in claim 1, wherein the chunk sets provide information to answer a user query, and the AI contextual search module does not provide an answer to the query.

16. A system, comprising:
a walled garden comprising content made up of a set of assigned or selected digital resources;
a converter to convert the digital resources in the walled garden from a closed format to an open, tagged format; and
an enabler that provides accommodations to assist users in consuming the content.

17. The system as claimed in claim 16, wherein a toggle on an enhancements user interface allows the users to activate the enabler.

18. The system as claimed in claim 16, wherein the enabler provides accommodations including read accommodation, simplified language, translations, read-to-me, speech-to-text, status text, and write accommodation.

19. The system as claimed in claim 18, wherein the accommodation comprises read-to-me text having a reading speed matched by a speed of text being displayed.

20. The system as claimed in claim 16, wherein the enabler provides an enabler display that is one of movable or fixed relative to a base display.

21. The system as claimed in claim 16, further comprising an enabler configuration module that allows configuration of accommodations.

22. The system as claimed in claim 21, wherein the enabler configuration module allows customization of the accommodations offers a customization for each user that is selected by one of the user, teacher, system administrator, and a school administrator.

23. The system as claimed in claim 16, further comprising a microphone activatable by the enabler to allow the users to dictate as part of a speech-to-text accommodation.

24. The system as claimed in claim 16, further comprising a speaker activatable by the enabler to allow the system to convert text to speech as part of a read-to-me accommodation.

25. The system as claimed in claim 16, wherein the accommodations provided by the enabler comprise a combination of different accommodations to create on accommodation set.
